(19) United States
(12) Patent Application Publication
(10) Pub. No.: US 2023/0222915 A1
(43) Pub. Date: Jul. 13, 2023

(54) INTERSECTION COLLISION AVOIDANCE SYSTEM

(71) Applicant: ERGOMAT, INC., Lorain, OH (US)

(72) Inventors: JOHN JOSEPH GIRARD, LAKEWOOD, OH (US); CLAUS MUNCH LENDAL, AVON LAKE, OH (US)

(21) Appl. No.: 17/900,819

(22) Filed: Aug. 31, 2022

Related U.S. Application Data
(60) Provisional application No. 63/239,376, filed on Aug. 31, 2021.

(51) Int. Cl. G08G 1/16

(52) U.S. Cl. CPC G08G 1/166; G08G 1/164

(57) ABSTRACT

An intersection collision avoidance system includes a warning device and at least one detection device, wherein: each detection device of the at least one detection device comprises a pair of sensors to distinguish a direction of movement of a person or vehicle from between movement along a first pathway toward an intersection and movement along the first pathway away from the intersection; and the warning device provides a visual and/or audible warning to another person or vehicle moving along a second pathway toward the intersection of likely imminent entry of the person or vehicle into the intersection in response to detection, by one of the at least two detection devices, of the person or vehicle moving toward the intersection along the first pathway.

### REFERENCE TO PROVISIONAL APPLICATION

This application is related to, and claims the benefit of the filing date of, U.S. Provisional Application Ser. No. 63/239,376 (Atty's Docket No. 7-745) filed Aug. 31, 2021 by John Joseph Girard et al., the disclosure of which is incorporated herein by reference.

### BACKGROUND

What is disclosed herein relates to the field of workplace safety—specifically to the provision of warnings of the impending entrance of traffic on crossing pathways into intersections through which both pedestrians and powered vehicles may pass.

It is commonplace, at relatively large workplaces, for the storage of large quantities of work supplies (e.g., construction materials, machine repair parts, packages being transported, etc.) within shelves, storage racks (e.g., racks for storing pallets of items), etc. to define a set of aisles. In turn, it is commonplace for such aisles to define, and meet with crossing pathways at, intersections where both pedestrians and vehicles (e.g., forklifts, tug vehicles with trailers, etc.) may cross. Unfortunately, it is also commonplace for such shelves, storage racks, etc. to become sufficiently high, and to be sufficiently densely packed with stored items, that pedestrians and operators of vehicles approaching such intersections are not able to look either over or through such highly and densely stored items, and into the paths in which crossing traffic may also be approaching those same intersections.

Such an intersection is sometimes colloquially referred to as having “cornfield corners” where the only way to visually check for the approach of crossing traffic on a crossing pathway through that intersection is for an approaching pedestrian or vehicle operator to extend their head into the intersection far enough to position their eyes to see around such corners and along the crossing pathway(s) along which crossing traffic may also be approaching that same intersection. Of course, extending one's head into such an intersection to gain such a view of such a crossing pathway incurs the risk of one's head being collided with by the very crossing traffic that one is looking for. Worse still, a vehicle operator who desires to so position their head to gain such a view with their eyes often needs to drive the vehicle partly into the intersection such that they also incur the risk of part of their vehicle being collided with by such crossing traffic.

Various approaches to eliminating, or at least reducing, such risks have been considered in the prior art. Among such approaches has been the installation of mirrors at such intersections to allow approaching pedestrians and/or operators of vehicles to gain a view along pathways that cross through such intersections. Unfortunately, such mirrors have begotten, at best, rather mixed results as it is not uncommon for pedestrians and/or vehicle operators to find the view provided by such mirrors frustrating to fully comprehend, as it often takes an unwelcome amount of time for the human brain to interpret the reflected image. More specifically, pedestrians and vehicle operators, alike, often find that they must slow down, or even stop moving, relative to such a mirror to give themselves time to fully appreciate both the direction of the reflected view that is being provided by such a mirror, as well as the fact that the reflected view is inverted (often by having to consciously remind themselves of these details). There is also the complication of needing to at least try to further interpret the reflected view to determine the distance of pedestrians and/or vehicles in the reflected image from the intersection, as well as whether those pedestrians and/or vehicles are moving toward the intersection. Such interpretation of distance is often additionally frustrated by the spatial distortion caused in the reflected view in the case of mirrors that are dome-shaped and/or otherwise curved in an effort to provide a wider view.

For pedestrians and/or vehicle operators accustomed to intersections at which such mirrors are provided, the performance of such “mental gymnastics” may be something that they have become acclimated to as a result of the visual cortexes of their brains having learned to interpret such views with sufficiently frequent and/or sufficiently sustained practice. However, other pedestrians and/or vehicle operators have been known to find such reflected views to be sufficiently disorienting and difficult to interpret that they are tempted to ignore such mirrors, and proceed with extending their heads and/or their vehicles partly into such intersection to gain a more direct view—thus, they may actually feel encouraged to paradoxically engage in the very collision-risking behavior that was sought to be stopped by the installation of such mirrors.

Also among such approaches has been the enforcement of such rules as requiring vehicle operators to use the horns of their vehicles each and every time they approach an intersection, and to do so regardless of whether they believe their is crossing traffic approaching on a pathway that crosses through that intersection, or not. Such use of vehicle horns can have the advantage of providing pedestrians and/or other vehicle operators with an indication of an approaching vehicle that may not be so easily ignored as a mirror might be. However, such a measure relies on vehicle operators reliably adhering to such requirements, and unfortunately, some vehicle operators are more consistent about doing so than others. Also, there can be a situation where an intersection is located in an area that is sufficiently noisy that either the noise itself, or the need to wear hearing protection in response to the noise, results in an inability to hear vehicle horns. Further, even in intersections where such use of vehicle horns is able to be heard clearly, such use of a vehicle horn can have the undesirable effect of startling a pedestrian or other vehicle operator such that they may be sufficiently disoriented from being startled that they undesirably delay responding to warning that is conveyed by the fact of a horn being so used. By way of example, a pedestrian may momentarily freeze in place, or an operator of another vehicle may momentarily delay their use of the brakes of their other vehicle. Thus, such use of vehicle horns may paradoxically cause behavior that leads to a collision.

What remains unaddressed is a need for an intersection collision avoidance system that provides a warning of the impending entry of crossing traffic in a manner that is automatic (so as to avoid requiring a particular consistent behavior from vehicle operators, etc.), and that gets the attention of pedestrians and vehicle operators in non-startling manner that is swiftly and easily understood.

### SUMMARY

What is disclosed herein includes pairs of sensors, as well as other components, of an intersection collision avoidance system configured to detect the movement of pedestrian(s) and/or vehicle(s) to an intersection along one pathway, and to automatically provide a warning of their likely imminent entry into the intersection to other pedestrian(s) and/or operator(s) of other vehicle(s) approaching the same intersection along another pathway.

An intersection collision avoidance system incorporates a warning device positioned to be visible by traffic from along a first pathway that extends through an intersection, and multiple detection devices positioned to monitor for traffic approaching the intersection along a second pathway that extends through the intersection where the second pathway crosses the first pathway. Such a collision avoidance system may be employed in a warehouse or other industrial environment in which one or more transport vehicles are employed to move about items through relatively narrow pathways that may be closely flanked with any of a variety of obstacles that limit visibility, such as shelving, storage racks, machinery, building walls, area partitions, guard rails, etc. In such an environment, there may be relatively little visibility of a first pathway used primarily by powered vehicles (e.g., forklifts, tugger trains, etc.) from a second pathway traveled primarily by people (e.g., on foot, on bicycles, on manually-powered scooters, etc.). Alternatively or additionally, such an intersection collision avoidance system may be employed in a situation where transport vehicles are used relatively infrequently such that people may be induced into complacency about the possibility of being struck by transport vehicles that may only occasionally intrude onto pathways that such people regularly use. Either or both of these situations may lead to a relatively high risk that person(s) traveling along the second pathway may enter into the intersection without being aware of the imminent danger that may be posed by such a powered vehicle that is just about to enter into that same intersection from along the first pathway.

Along each approach to an intersection by a secondary pathway used primarily by people, a separate detection device incorporating a pair of sensors may be positioned to detect movement therealong. The pair of sensors may cooperate to distinguish movement along the secondary pathway toward the intersection from movement along the secondary pathway away from the intersection. Upon detecting movement along the secondary pathway toward the intersection, one of the detection devices may signal a warning device to provide a warning indication, to operators of powered vehicles that may be approaching the intersection along a primary pathway, of the likely imminent entry of person(s) along the secondary pathway into the intersection. In this way, operators of such powered vehicles may take action either to momentarily stop just before entering into the intersection, or to at least slow down to better enable stopping in response to the entry of person(s) into the intersection from along the secondary pathway.

In some embodiments, the pair of sensors may be a pair of light detection and ranging (LIDAR) components employing laser light to detect objects that are within the path of the laser light. Each detection device may be sized and/or shaped to cause its pair of sensors to be at two differing positions along the secondary path such that the laser beam emanating from each sensor extends across the secondary path at a different location. In this way, a person or object that moves along the secondary path in the vicinity of the detection device may first move into the path of one of the beams, and then into the path of the other. Depending on the direction in which the person or object was moving along the secondary path, that person or object may move into the path of one or the other of the two beams, first. The order in which entry is made into the paths of the two beams may be detected by the detection device and used to make a determination of whether the person or object is moving toward the intersection, or away therefrom.

The warning device may incorporate audible and/or visual warning components (e.g., buzzers, horns, flashing lights, illuminable lettering, etc.), and the warning device may be positioned at or near the intersection to enable audible and/or visual warnings therefrom to be heard and/or seen, respectively, by operators of vehicles moving along the primary pathway toward the intersection. Among the visual warning components may be visual indicators (e.g., lights, mechanically-moved flags, etc.) that, in addition to providing a visual warning of the imminent entry of person(s) into the intersection, also provide a visual indication of the direction from which such person(s) are about to enter the intersection along the secondary path. Such a visual indication of direction may provide operators of vehicles with an indication of where to look while watching for person(s) who are about to enter the intersection. Where an audible warning is also provided, such an audible warning may serve to draw the gaze of operators of vehicles more immediately toward the visual warning (including such a visual indication of direction) to address situations in which their gaze was directed elsewhere.

Alternatively or additionally, among the audible warning components may be a pair of audible indicators (e.g., buzzers, horns, etc.) that are each positioned adjacent to a different one of the approaches of the secondary pathway to the intersection to provide an audible indication of the direction from which person(s) may be about to enter the intersection. This may be done in addition to or in lieu of the provision of a visual indication of direction.

Regardless of the exact nature of audible and/or visual warning provided to operators of vehicles moving along the primary pathway toward the intersection, differing techniques may be used to control the duration of the provision of such warnings. It may be that each warning is configured to be provided for a pre-selected duration of time that may be based on the amount of time that is expected to be required for people to fully cross the intersection while moving along the secondary pathway such that they will have cleared the primary pathway. It may be that differing durations of time are used based on the direction in which people move along the secondary path.

In various embodiments, the warning and detection devices used at a particular intersection may be linked wirelessly and/or with any of a variety of cabling-based linkage. It is through such linkages that each detection device may provide an indication to the warning device of movement of person(s) along a secondary pathway toward an intersection to thereby cause the warning device to provide a warning to operators of powered vehicles that are approaching the intersection along a primary pathway. Regardless of the exact manner in which such linkages may be implemented, a pairing process may be used to enable the warning and detection devices to communicate with each other, while also ignoring communications that may emanate from warning and/or detection devices used at other intersections. It may additionally be that such a pairing process may be employed to provide an opportunity to configure each device to accommodate various aspects of the particular intersection, including and not limited to, wireless transmission range, sensor component range, type of audio and/or visual warning provided, interpretations of directional indications exchanged among the devices, duration(s) of the provision of a warning, etc.

In various embodiments, one or more of the warning and detection devices may incorporate a battery or other form of internal energy source to provide electrical power, and/or may receive electrical power from an external source (e.g., AC mains). In embodiments in which the warning and detection devices are linked via cabling-based linkages, such linkages may also convey electrical power thereamong such that one of the devices provides electrical power to the others.

### BRIEF DESCRIPTION OF THE DRAWINGS

A fuller understanding of what is disclosed in the present application may be had by referring to the description and claims that follow, taken in conjunction with the accompanying drawings, wherein:

FIGS. 1A-B depict aspects of an example embodiment of an intersection collision avoidance system, and of an example installation thereof at an intersection.

FIGS. 2A-B depict aspects of an example embodiment of a single detection device of the system of FIGS. 1A-B.

FIGS. 3A-B depict aspects of an example embodiment of a warning device of the system of FIGS. 1A-B.

FIG. 4A depicts aspects of an alternate example of installation of a pair of embodiments of the intersection collision avoidance system of FIGS. 1A-B.

FIG. 4B depicts aspects of an example of installation of an alternate embodiment of the intersection collision avoidance system of FIGS. 1A-B.

FIG. 5 depicts aspects of another example of installation of an alternate embodiment of the intersection collision avoidance system of FIGS. 1A-B.

FIGS. 6 provides a flow chart of the operation of an embodiment of a detection device of the system of FIGS. 1A-B.

### DETAILED DESCRIPTION

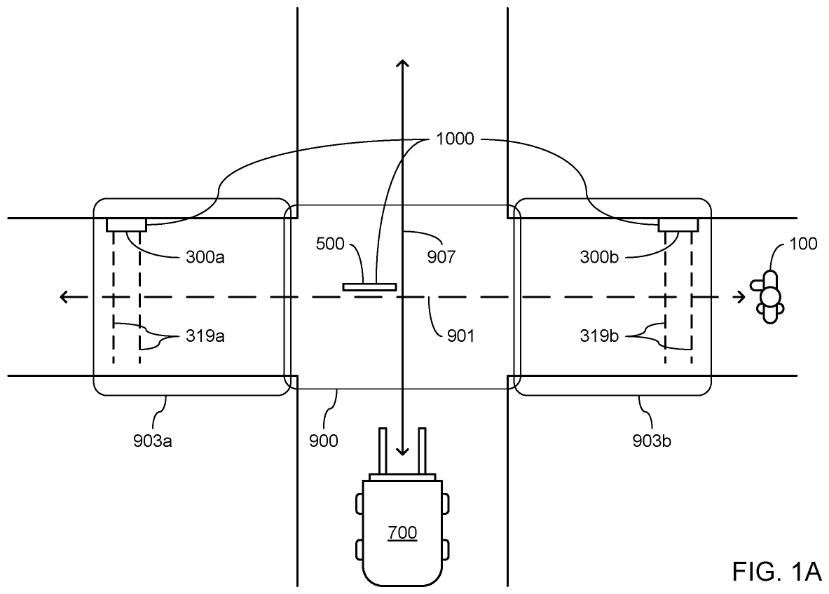

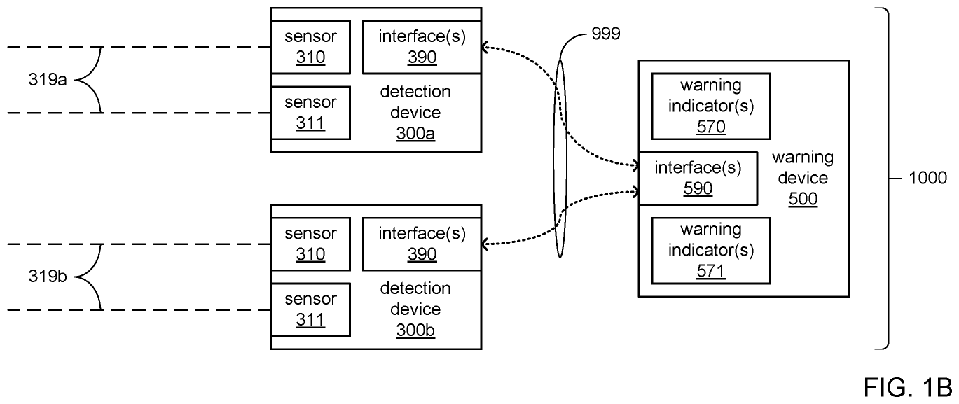

Turning to FIGS. 1A and 1B, an example embodiment of an intersection collision avoidance system 1000 is depicted as having been installed at an intersection 900 at which a primary pathway 907 is crossed by a secondary pathway 901. As depicted, the primary pathway 907 may be used largely by powered vehicles, such as the depicted forklift 700. In contrast, the secondary pathway 901 may be used largely by people traveling on foot (such as the depicted person 100) or by people employing a human-powered vehicle (e.g., a bicycle or scooter, not specifically shown). As also depicted, the boundaries of each of one or both of the pathways 901 and 907 may be defined by walls, partitions, guard rails, shelving, storage racks, stacked boxes and/or other containers, machinery, etc. such that there may be limited visibility between portions of the primary pathway 907 close to the intersection 900 and portions of the secondary pathway 901 close to the intersection 900. Thus, it may be that the depicted person 100 may approach the intersection 900 along the secondary pathway 901, and then proceed into the intersection 900 without being aware of the approach of the depicted forklift 700. Correspondingly, an operator (not specifically shown) of the depicted forklift 700 may similarly approach the intersection 900 along the primary pathway 907, and then proceed into the intersection 900 without being aware of the approach of the depicted person 100. Unfortunately, the result may be that the person 100 is struck by the forklift 700, and may be severely injured or killed.

In an effort to avoid such an event, detection devices 300a and 300b of the intersection collision avoidance system 1000 are positioned along approaches 903a and 903b, respectively, of the secondary pathway 901 to the intersection 900 to detect the movement of the person 100 toward the intersection 900, and a warning device 500 of the intersection collision avoidance system 1000 is positioned at or adjacent to the intersection 900 to provide a warning of such movement toward the intersection 900 of persons 100 to operators of powered vehicles 700.

Each of the detection devices 300a and 300b may incorporate a pair of sensors 310 and 311 to that emit laser light along pairs of paths 319a and 319b, respectively, that each cross the secondary pathway 901 at differing locations to detect movement therealong. Again, such pairs of sensors 310 and 311 additionally enable the detection of the direction of movement along the secondary pathway 901. It should be noted that, for each detection device 300a and 300b, the paths making up each pair of paths 319a and 319b, respectively, may or may not extend in parallel.

The warning device 500 may be coupled to each of the detection devices 300a and 300b via wireless and/or cabling-based linkages 999. More specifically, each of the detection devices 300a and 300b may incorporate one or more interfaces 390, and the warning device 500 may incorporate corresponding one or more interfaces 590. Each one of such interfaces 390 and/or 590 may support any of a variety of types of wireless linkage 999 (e.g., RF, IR, ultrasound, etc.), and/or may support any of a variety of types of cabling-based linkage 999 (e.g., electrically conductive and/or fiber optic). More than one type of interface 390 may be incorporated into each detection device 300a and 300b, and/or more than one type of interface 590 may be incorporated into the warning device 500 to provide some degree of flexibility in choosing type(s) of link 999 to be implemented thereamong.

Upon detecting movement of one or more persons 100 within one of the approaches 903a or 903b along the secondary pathway 901, and toward the intersection 900, the corresponding one of the detection devices 300a or 300b may use such a linkage 999 to transmit a signal to the warning device 500 indicative of such detected movement. In response, the warning device 500 may provide, to operators of powered vehicles 700 that are moving toward the intersection 900 along the primary pathway 907, a warning of the imminent entrance of person(s) 100 and/or other objects into the intersection 900.

As will be discussed in greater detail, the warning device 500 may be shaped and/or sized to have the physical configuration of a two-sided sign. Differing warning indicators 570 and 571 may be installed on different ones of the two sides to provide audio and/or visual warning indications in both directions along the primary pathway 901 to operators of powered vehicles 700 approaching the intersection 900. Again, such warnings may include warning sounds and/or visual indications.

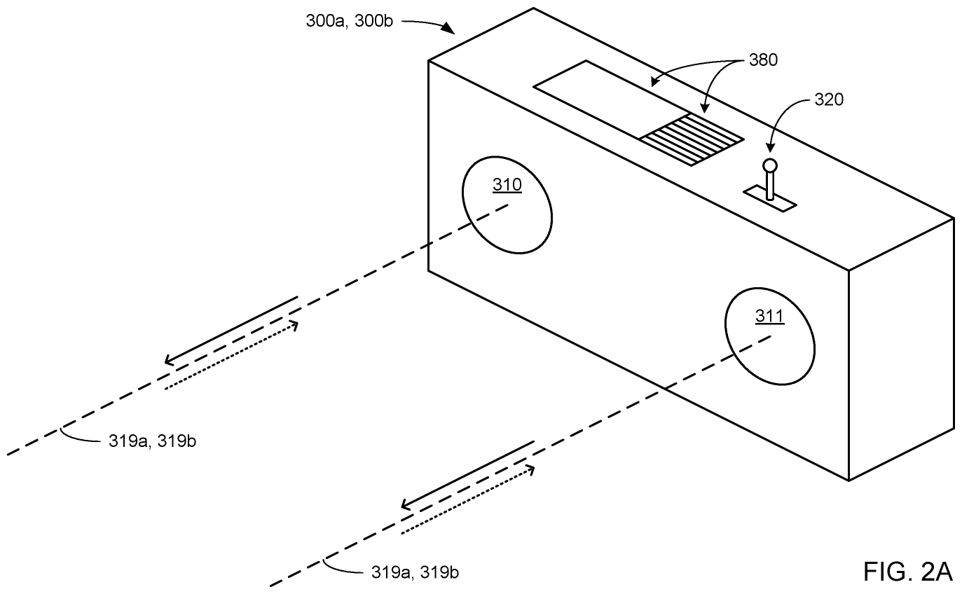

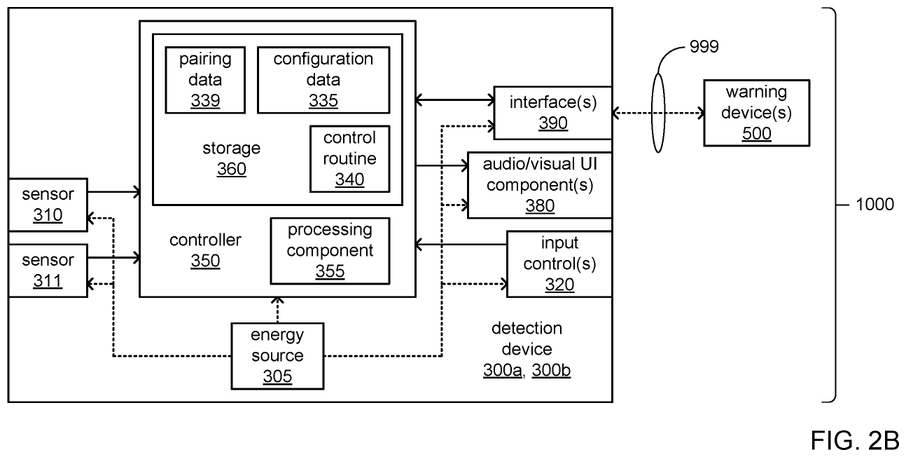

FIGS. 2A and 2B, together, depict an example of embodiment of one of the detection devices 300a or 300b of the intersection collision avoidance system 1000.

As depicted, the detection device 300a/300b may incorporate an energy source 305, the pair of sensors 310 and 311, one or more input controls 320, a controller 350, one or more audio/visual user interface (UI) components 380, and/or the one or more interfaces 390. The controller 350 may incorporate a processing component 355 and a storage 360. The storage 360 may store configuration data 335, pairing data 339 and/or a control routine 340.

The energy source 305 may include any of a variety of type of electric power conversion circuit (e.g., a power supply) that converts electrical energy received from an external source (e.g., AC mains electrical power) into electrical energy having characteristics (e.g., levels of voltage and/or current) that are appropriate for being provided to others of the aforementioned components of the detection device 300a/300b. Alternatively or additionally, the energy source 305 may include any of a variety of type of electric power storage circuit (e.g., with one or more batteries) that stores electrical energy for subsequent provision with appropriate characteristics to others of the aforementioned components of the detection device 300a/300b.

As previously discussed, the pair of sensors 310 and 311 may be LIDAR components that each employ laser light emanating along one of a pair of paths 319a/319b to detect person(s) 100 and/or objects moving along a portion of a secondary pathway 901 on an approach 903a/903b that leads to an intersection 900 at which the secondary pathway 901 crosses a primary pathway 907. The detection device 300a/300b may be given a physical configuration of sufficient size as to allow a spacing between the sensors 310 and 311 that is wide enough to enable the detection of a direction of movement of person(s) 100 along the secondary pathway 901. More specifically, the pair of paths 319a/319b, which may extend in parallel across the secondary pathway 901 from the detection device 300a/300b, and may need to spaced sufficiently apart as to enable clear detection of the direction of movement of a person 100 or an object along the secondary pathway 901 that first enters into one of the paths of the pair of paths 319a/319b, and then enters into the other of the paths of the pair of paths 319a/319b. Again, the order of which path of the pair of paths 319a/319b is entered into first, and which path of the pair of paths 319a/319b is entered into second, may be employed to determine the direction of movement along the secondary pathway 901 toward or away from the intersection 900.

It should be noted, however, that despite the specific discussion herein of the use of LIDAR technology by the sensors 310 and 311, other embodiments are possible in which other technologies may be used. By way of example, IR light projected along the pair of paths 319a/319b through use of lenses, and then reflected back along those same paths by external reflectors (not shown) may be used in lieu of laser light. Alternatively, ultrasound that is directionally emitted along the pair of paths 319a/319b, along with any reflections thereof back along the pair of paths 319a/319b, may be used.

The one or more manually operable input controls 320 and/or the one or more audio/visual UI components 380 may be used to provide a user interface by which various features of the detection device 300a/300b may be configured and/or controlled. The input control(s) 320 may include any of a variety and/or combination of lever switches, paddle switches, DIP switches, buttons, keypads, touchpads, joysticks, microphones, etc., to enable the acceptance of manual input and/or voice input as part of a UI. The audio/visual UI component(s) 380 may include any of a variety and/or combination of light-emitting diodes (LEDs), analog meters, dot-matrix displays, multi-segmented character displays (e.g., seven-segment displays), buzzers, piezo elements, speakers, etc., to enable the provision audio and/or visual output as part of a UI.

The processing component 355 may be any of a variety of processor, microcontroller, etc. The storage 360 may be any of a variety and/or combination of storage devices capable of storing data and/or executable instructions for access by the processing component 355. In particular, the control routine 340 may include executable instructions that are executable by the processing component 355 to cause the processing component 355 to perform various operations to, in turn, cause the detection device 300a/300b to perform its various aforedescribed functions.

As previously discussed, the interface(s) 390 may support the connection of the detection device 300a/300b to a warning device 500 via any of a variety of wireless or cabling-based linkage 999. Again, there may be more than one of the interfaces 390 to provide flexibility in using linkages 999 of different types.

In executing the control routine 340, the processing component 355 may be caused to operate the input control(s) 320 and/or the audio/visual UI component(s) 380 to provide a user interface by which the detection device 300a/300b may be powered on and/or off, may be configured for use, may be paired with a warning device 500, and/or may allow one or more of its functions to be tested.

Among the configurable aspects of the detection device 300a/300b may be a range distance of the sensors 310 and 311 to accommodate secondary pathways 901 of different widths. By way of example, the range distance may need to be increased to fully extend across a wider secondary pathway 901 to avoid missing the movement of persons 100 and/or objects along portions thereof that are further away from the detection device 300a/300b. Also by way of example, the range distance may need to be decreased to avoid extending beyond the width of a narrower secondary pathway 901 and detecting a wall, guard rail or other nearby structure in a manner that could cause false positive detections by one or both of the sensors 310 and 311. Further by way of example, the range distance may need to be adjusted to counteract the influence of various sources of noise that may interfere with the light, laser light, and/or sound(s) that may be employed by the sensors 310 and 311.

Also among the configurable aspects of the detection device 300a/300b may be which direction of movement along a secondary pathway 901 is consistent with movement therealong towards an intersection 900. In some embodiments, such configuration may be accomplished by operating the input control(s) 320 to place the detection device 300a/300b into a mode in which such a direction may be configured by moving a hand sequentially through each path of the pair of paths 319a/319b in a direction that is consistent with movement toward an intersection. Alternatively or additionally, the input control(s) 320 may simply include a direction switch providing a lever, paddle or other manually operable component that is able to be manually operated to provide input indicative of such a direction of movement.

Further among the configurable aspects of the detection device 300a/300b may be one or more aspects of the manner in which a warning device 500 may be provided with a signal through a linkage 999 to the effect that movement of person(s) 100 and/or objects toward an intersection 900 has been detected. Depending on the exact manner in which such a linkage 999 is implemented using a wireless and/or cabling-based technology, such aspects may include signaling and/or protocol aspects (e.g., handshake protocols, data formatting, selection of frequency, selection of transmission range, selection of voltage level, selection of current level, selection of light transmission strength, etc.).

Still further among the configurable aspects of the detection device 300a/300b may whether both a signal to the warning device to provide a warning and another signal to the warning device to cease to provide a warning are to be transmitted by the detection device 300a/300b, or just a signal to the warning device to provide a warning, but relying on the warning device to employ a selected time limit on the amount of time during which the warning is provided. Where the detection device 300a/300b is to send both signals to the warning device, the detection device 300a/300b may be caused to employ a selected time limit on the amount of time during which the warning is provided, before transmitting the signal to the warning device to cease to provide a warning.

It may be that various default settings for such configuration aspects may be stored as at least a portion of the configuration data 335 that may be maintained in a non-volatile portion of the storage 360. Alternatively or additionally, indications of the configuration settings that are selected may be stored as at least a portion of the configuration data 335, and possibly in a portion of the storage 360 that may be volatile such that erasure of selected settings may occur if electric power is removed (e.g., through the removal of a battery and/or through disconnection from A/C mains).

Additionally, in some embodiments, processing component 355 may be caused to use the detection of movement of person(s) 100 and/or object(s) either toward or way from an intersection 900 as a basis for a cumulative count of persons(s) 100 and/or object(s) moving toward the intersection, and/or a cumulative count of person(s) 100 and/or objects moving away from the intersection. Such count(s) may be maintained as a kind of census of a degree of activity of one of the approaches to the intersection. In some embodiments, separate counts for movement toward the intersection and away from the intersection may be combined to derive a net count where perhaps each instance of detection of movement of person(s) and/or object(s) toward the intersection increases the net count by 1, while each instance of detection of movement of person(s) and/or object(s) away from the intersection decreases the net count by 1. From time to time, such count(s) may be accessed and/or retrieved from each detection device 300 positioned at an intersection, and may compared and/or otherwise analyzed to gain a more complete picture of the overall movement activity through the intersection.

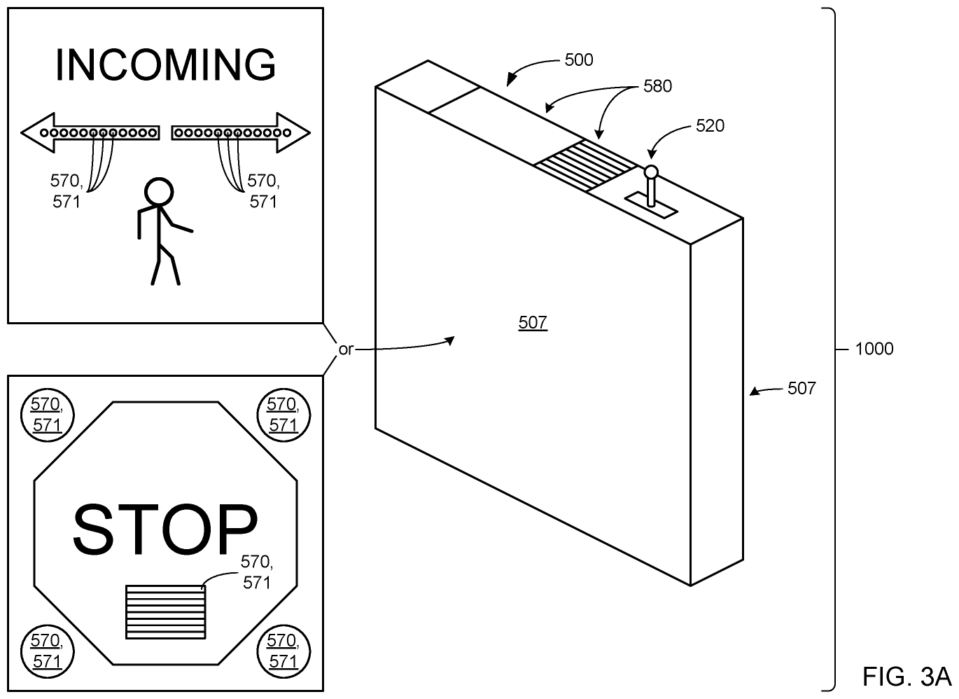

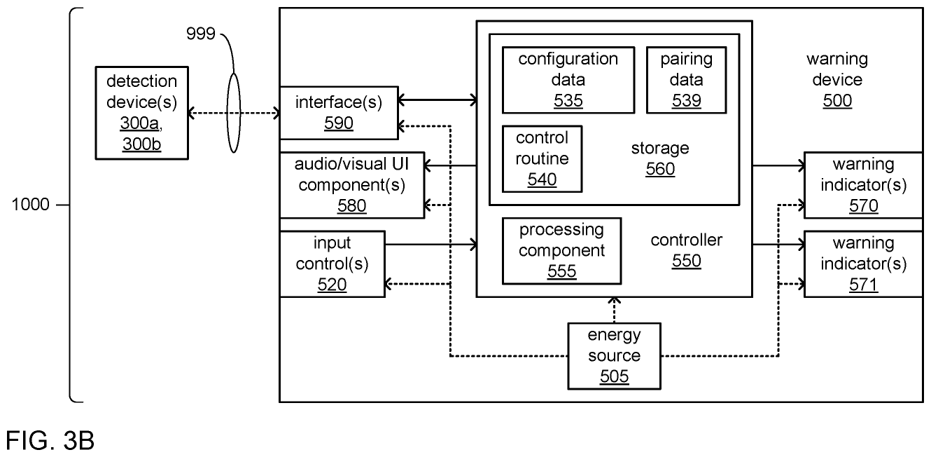

FIGS. 3A and 3B, together, depict example embodiments of the warning device 500 of the intersection collision avoidance system 1000.

As depicted, the warning device 500 may incorporate an energy source 505, one or more input controls 520, a controller 550, one or more warning indicator(s) 570 and/or 571, one or more audio/visual user interface (UI) components 580, and/or the one or more interfaces 590. The controller 550 may incorporate a processing component 555 and a storage 560. The storage 560 may store configuration data 535, pairing data 539 and/or a control routine 540.

Similar to the energy source 305 of the detection devices 300a and 300b, the energy source 505 of the warning device 500 may include any of a variety of type of electric power conversion circuit that converts electrical energy received from an external source (e.g., AC mains electric power) into electrical energy having characteristics that are appropriate for being provided to others of the aforementioned components of the warning device 500. Alternatively or additionally, the energy source 505 may include any of a variety of type of electric power storage circuit that stores electrical energy for subsequent provision with appropriate characteristics to others of the aforementioned components of the warning device 500.

The one or more manually operable input controls 520 and/or the one or more audio/visual UI components 580 may be used to provide a user interface by which various features of the warning device 500 may be configured and/or controlled. Similar to the input control(s) 320 of each of the detection devices 300a and 300b, the input control(s) 520 of the warning device 500 may include any of a variety and/or combination of lever switches, paddle switches, DIP switches, buttons, keypads, touchpads, joysticks, microphones, etc., to enable the acceptance of manual input and/or voice input as part of a UI. Also similarly, the audio/visual UI component(s) 580 may include any of a variety and/or combination of LEDs, analog meters, dot-matrix displays, multi-segmented character displays, buzzers, piezo elements, speakers, etc., to enable the provision audio and/or visual output as part of a UI.

Similar to the processing component 355 of each of the detection devices 300a and 300b, the processing component 555 of the warning device 500 may be any of a variety of processor, microcontroller, etc. Also similarly, the storage 560 may be any of a variety and/or combination of storage devices capable of storing data and/or executable instructions for access by the processing component 555. In particular, the control routine 540 may include executable instructions that are executable by the processing component 555 to cause the processing component 555 to perform various operations to, in turn, cause the warning device 500 to perform its various aforedescribed functions.

As previously discussed, the warning indicators 570 and 571 may include any of a variety of audio and/or visual indicators, including and not limited to, buzzers, horns, flashing lights, dot-matrix lighting devices, multi-segmented character lighting devices, illuminated signage, etc., to provide a warning indication to operators of powered vehicles 700 of the likely imminent entrance of persons 100 and/or other objects into an intersection 900. Thus, in some embodiments, the warning device 500 may be of a relatively simple configuration that incorporates just a single warning indicator 570 in the form of a single bright rotating light that is meant to be visible from at least both directions along the primary pathway 907.

However, as also previously discussed, the warning device 500 may generally take the form of a double-sided sign such that its casing has a size and/or shape that defines a pair of presentation surfaces 507 onto which various warning indicia may be printed and/or onto which various placards carrying warning indicia may be affixed. In such embodiments of the warning device 500, one or more warning indicators 570 of various types may be positioned on one of the two presentation surfaces 507, and one or more warning indicators 571 of various types may be positioned on the other of the two presentation surfaces 507.

Thus, as specifically depicted, one of the two presentation surfaces 507 may carry (or have otherwise affixed to it) a sign that may also include multiple warning indicators 570, while the other of the two presentation surfaces 507 may carry (or have otherwise affixed to it) a matching sign that may also include multiple warning indicators 571. By way of one example, such multiple warning indicators 570 and 571 may include rows of lights that may operated in a synchronized manner that provides a moving dot or moving line effect that may indicate a direction in which person(s) 100 and/or other objects are likely imminently about to move across a primary pathway 901 at an intersection 900. By way of another example, such multiple warning indicators 570 and 571 may include a combination of an audible indicator (e.g., a buzzer, horn, speaker, etc.) and multiple visual indicators (e.g., a set of lights that may flash in a synchronized pattern of alternating sets of lights), as in the case of the depicted “STOP” sign.

Similar to the interface(s) 390 of each of the detection devices 300a and 300b, and as previously discussed, the interface(s) 590 may support the connection of the warning device 500 to the detection devices 300a and 300b via any of a variety of wireless or cabling-based linkage 999. Again, there may be more than one of the interfaces 590 to provide flexibility in using linkages 999 of different types.

In executing the control routine 540, the processing component 555 may be caused to operate the input control(s) 520 and/or the audio/visual UI component(s) 580 to provide a user interface by which the warning device 500 may be powered on and/or off, may be configured for use, may be paired with each of the detection devices 300a and 300b, and/or may allow one or more of its functions to be tested.

Among the configurable aspects of the warning device 500 may be a brightness, color, rate of flashing and/or pattern of flashing of one or more lighted ones of the warning indicators 570 and/or 571. Alternatively or additionally, among the configurable aspects of the warning device 500 may be acoustic volume and/or type of sound output by one or more audible ones of the warning indicators 570 and/or 571.

For embodiments of the warning device 500 that provide an indication of direction in which person(s) 100 and/or objects will likely imminently cross through an intersection 900, the configurable aspects of the warning device 500 may be which direction of movement is to be indicated using the warning indicators 570 and/or 571 for signals received from each detection device 300a and 300b.

Further among the configurable aspects of the warning device 500 may be one or more aspects of the manner in which the warning device 500 may receive signals from each of the detection devices 300a and 300b through linkage(s) 999 to the effect that movement of person(s) 100 and/or objects toward an intersection 900 has been detected. Again, depending on the exact manner in which such a linkage 999 is implemented using a wireless and/or cabling-based technology, such aspects may include signaling and/or protocol aspects (e.g., handshake protocols, data formatting, selection of frequency, selection of transmission range, selection of voltage level, selection of current level, selection of light transmission strength, etc.). It should be noted that, in some embodiments, the warning device 500 may be configurable to support the use of different types of linkage 999 and/or the use of different signaling and/or protocols with each of the detection devices 300a and 300b.

Still further among the configurable aspects of the warning device 500 may be the amount of time for which each warning indication is provided in response to an indication received from a detection device 300a or 300b that movement of person(s) 100 and/or objects toward an intersection has been detected. In some embodiments, provision may be made for enabling a fixed duration of time to be selected from a set of durations, and/or to allow manual entry of a specified duration of time. Again, such durations of time may be separately specified for signals received from each different one of the detection devices 300a and 300b in some embodiments.

However, as another alternative, it may be that the warning device 500 is configurable to allow the amount of time to at least be controlled by a detection device 300a/300b. More specifically, it may be that each of the detection devices 300a and 300b are to transmit to the warning device 500 both a signal to the warning device 500 to provide a warning and another signal to the warning device 500 to cease providing a warning. As discussed earlier, in such a configuration, it may be that each of the detection devices 300a and 300b employ one or more preselected time periods to control at least the duration of the provision of a warning by the warning device. In such a configuration, the warning device 500 may then do little more than to simply follow the commands transmitted to it by each of the detection devices 300a and 300b.

As yet another alternative, it may be that the warning device 500 is configured or configurable to shorten the duration of the warning that it provides in response to further signals from one or both of the detection devices 300a and 300b. More specifically, where one of the detection devices 300a has signaled the warning device 500 with an indication of person(s) 100 and/or other objects about to enter the intersection such that the warning device 500 begins providing a warning indication, the duration of time of that warning indication may at least be shortened (if not ended altogether) in response to the receipt of a corresponding indication from the other of the detection devices 300b of person(s) 100 and/or other objects having been detected as having moved away from the intersection 900. Such a signal from the other detection device 300b may be deemed an indication that the person(s) 100 and/or other objects detected by the detection device 300a as moving toward the intersection 900 have subsequently been detected by the detection device 300b as moving away from the same intersection 900 after having crossed it.

Similar to the configuration of the detection devices 300a and 300b, it may be that various default settings for the configuration of aspects of the warning device 500 may be stored as at least a portion of the configuration data 535 that may be maintained in a non-volatile portion of the storage 560. Alternatively or additionally, indications of the configuration settings that are selected may be stored as at least a portion of the configuration data 535, and possibly in a portion of the storage 560 that may be volatile such that erasure of selected settings may occur if electric power is removed (e.g., through the removal of a battery and/or through disconnection from A/C mains).

Additionally, in embodiments of the intersection collision avoidance system 1000 in which one or more counts of instances of movement of person(s) 100, vehicles 700 and/or other objects are being maintained, it may be that the processing component 555 is caused to store and/or combine counts indicative of instances of such movement detected by each of the detection devices 300 that are in communication with the warning device 500. In some embodiments, it may be that an overall net count may be maintained of detected movements toward the intersection by any of the detection devices 300 in communication with the warning device 500 (which may cause an incrementing of the overall net count), and of detected movements away from the intersection by any of those detection devices 300 (which may cause a decrementing of the overall net count). Again, such count(s) may be employed as part of monitoring various aspects of the degree of activity of movement through the intersection.

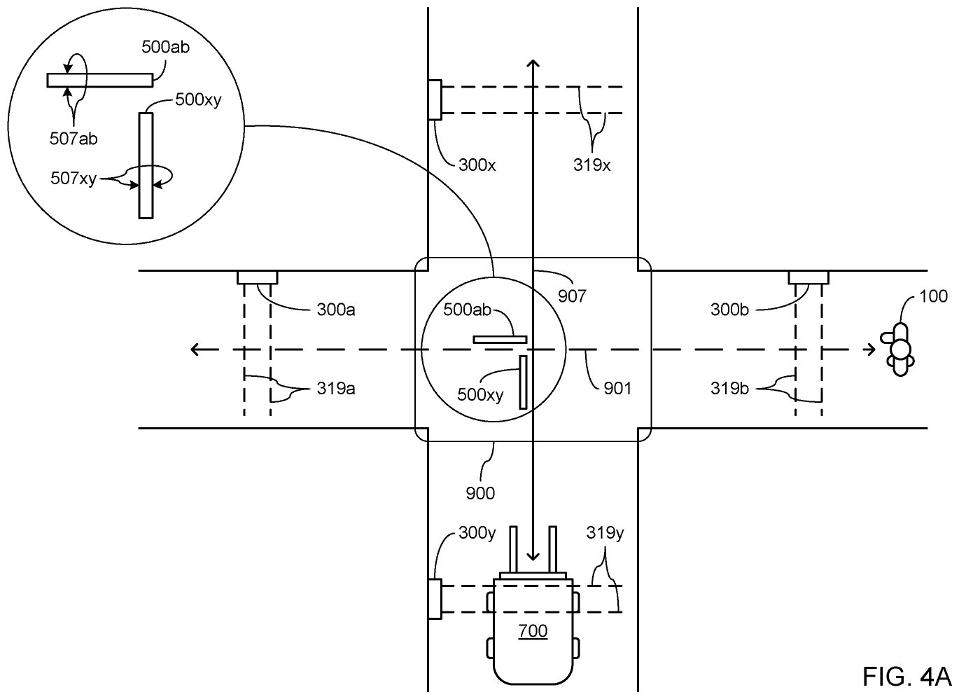

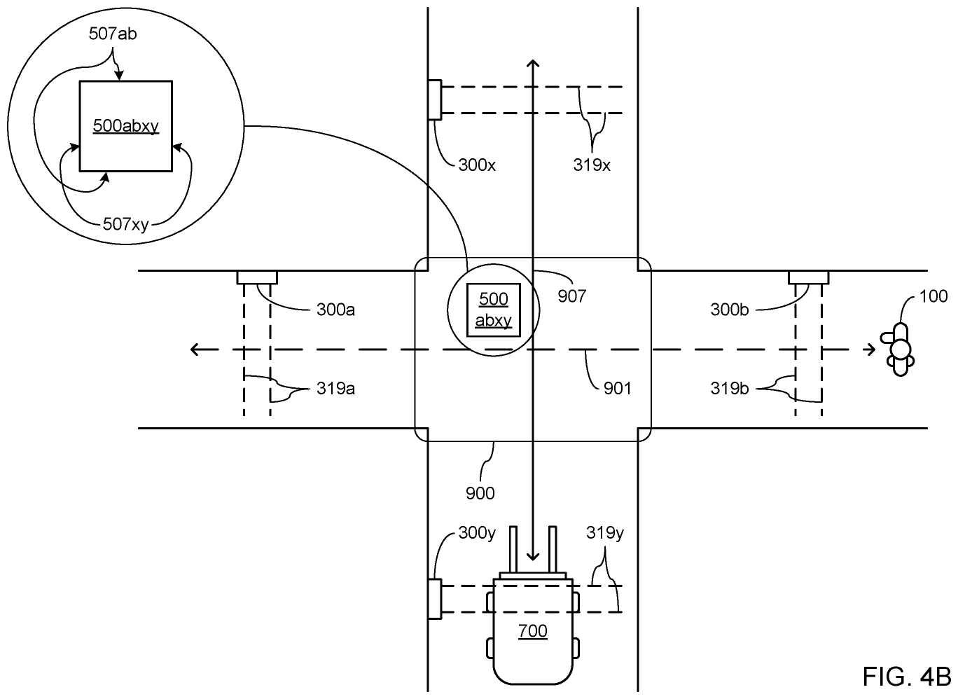

FIGS. 4A and 4B depict examples of alternate embodiments of the intersection collision avoidance system 1000 and/or of an installation example.

FIG. 4A depicts the use of a pair of the intersection collision avoidance system 1000 of FIGS. 1A-B in which a second one of such systems is installed to monitor the primary pathway 907 for the approach of powered vehicles 700 approaching the an intersection 900 to provide warning indications thereof to person(s) 100 and/or other objects approaching the same intersection 900 on the secondary pathway 901. In this way, warning indications are provided to both person(s) 100 and operators of powered vehicles 700.

As FIG. 4A clearly depicts, although the intersection collision avoidance system 1000 has been depicted in the preceding figures, and has been discussed in the preceding text, as being used with its detection devices 300a and 300b positioned to detect possibly imminent entry of person(s) 100 and/or objects along a secondary pathway 901 into an intersection 900 for purposes of providing warnings to vehicle operators approaching the intersection 900 along a primary pathway 907, there is nothing about the intersection collision avoidance system 1000 that prevents its use from providing a warning, to person(s) approaching the intersection 900 along the secondary path 901, about the likely imminent entry of vehicle(s) 700 into the intersection 900 along the primary path 907.

More specifically, and especially where LIDAR components are used as the sensors 310 and 311, there may be little difference in detecting the approach of person(s) 100 or vehicle(s) 700 to an intersection 900.

Thus, and as depicted, there may be two of the intersection collision avoidance systems 1000 of the embodiment of FIGS. 1A-B installed. In such a double installation, each of the depicted detection devices 300a and 300b may be capable of detecting movement of person(s) 100 and/or vehicle(s) 700 toward the intersection 900 along the pathway 901, and signaling the depicted warning device 500ab to provide a warning, on its pair of presentation surfaces 507ab, to person(s) 100 and/or vehicle(s) 700 moving toward the intersection 900 along the pathway 907. And also, in such a double installation, each of the depicted detection devices 300x and 300y may be capable of detecting movement of person(s) 100 and/or vehicle(s) 700 toward the intersection 900 along the pathway 907, and signaling the depicted warning device 500xy to provide a warning, on its pair of presentation surfaces 507xy, to person(s) 100 and/or vehicle(s) 700 moving toward the intersection 900 along the pathway 901.

FIG. 4B depicts the use of a single one of an alternate embodiment of the intersection collision avoidance system 1000 that differs from the embodiment of FIGS. 1A-B and differs from the example installation of FIG. 4A inasmuch as a single alternate 4-sided embodiment of warning device 500abxy is installed at the intersection 900 in place of the pair of warning devices 500ab and 500xy depicted in FIG. 4A.

More specifically, the depicted alternate warning device 500abxy may have a more rectangular/square shape that provides it with two pairs of presentation surfaces 507ab and 507xy, which may functionally correspond to the presentation surfaces 507ab and 507xy of the warning devices 500ab and 500xy, respectively, of FIG. 4A. Thus, functionally, this single alternate warning device 500abxy of FIG. 4B may serve to perform the identical function as the pair of warning devices 500ab and 500xy of FIG. 4A.

Thus, the single warning device 500abxy may accept signals from all four of the detection devices 300a, 300b, 300x and 300y. With such a 4-sided alternate embodiment of warning device 500abxy, each of the depicted detection devices 300a and 300b may be capable of detecting movement of person(s) 100 and/or vehicle(s) 700 toward the intersection 900 along the pathway 901, and signaling the single warning device 500abxy to provide a warning, on its pair of presentation surfaces 507ab, to person(s) 100 and/or vehicle(s) 700 moving toward the intersection 900 along the pathway 907. And also, with such a 4-sided alternate embodiment of warning device 500abxy, each of the depicted detection devices 300x and 300y may be capable of detecting movement of person(s) 100 and/or vehicle(s) 700 toward the intersection 900 along the pathway 907, and signaling the single depicted warning device 500abxy to provide a warning, on its other pair of presentation surfaces 507xy, to person(s) 100 and/or vehicle(s) 700 moving toward the intersection 900 along the pathway 901.

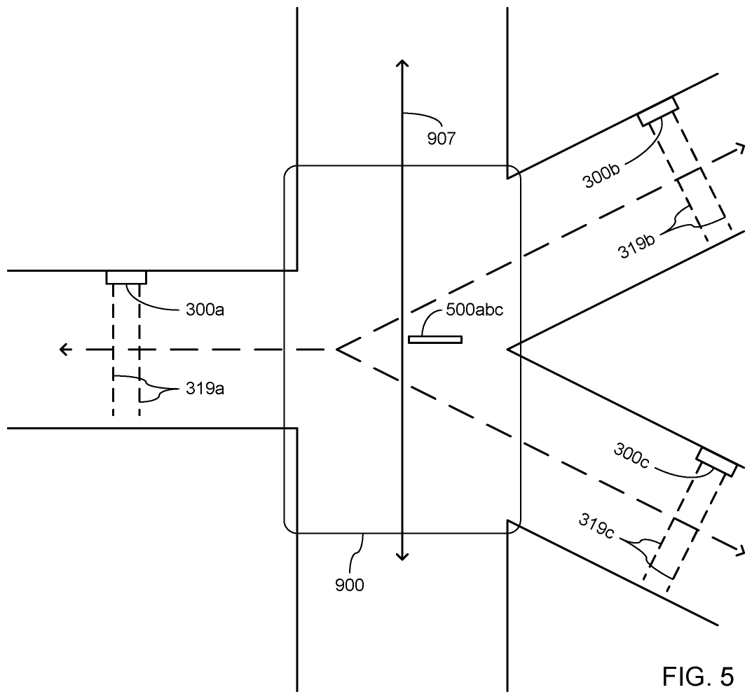

FIG. 5 depicts the use of another variant of the intersection collision avoidance system 1000 of FIGS. 1A-B in which a third detection device 300c is added to the already included detection devices 300a and 300b to monitor the approach of person(s) 100 and/or objects along an additional branch of a Y-shaped variant of the secondary pathway 901.

As FIG. 5 clearly depicts, various embodiments of the intersection collision avoidance system 1000 are possible in which different quantities of detection devices 300 may be included to accommodate more complex intersections than the earlier depicted examples of relatively simple “4-way cross” varieties of intersections 900.

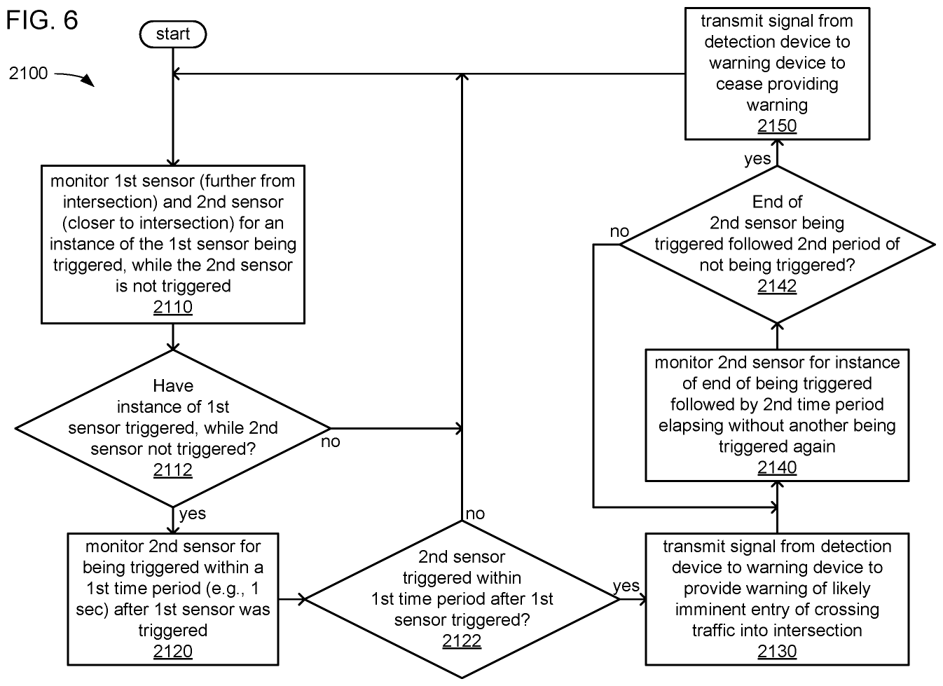

FIG. 6 provides a flowchart 2100 of an embodiment of operation of a detection device (e.g., any of the detection devices 300a, 300b, 300c, 300x or 300y of an intersection collision avoidance system 1000).

As has been discussed, each of such detection devices may have a pair of sensors 310 and 311 that are each triggered when a person, a vehicle or still another object passes through a path of light, sound, etc. emitted therefrom. Where each of the sensors 310 and 311 is a LIDAR component, such an emission from each sensor may be a beam of laser light, with reflections therefrom that occur within a selected distance (e.g., 6 feet) serving to trigger that sensor. As has also been discussed, such pairs of sensors are arranged horizontally such that one is closer to the corresponding intersection than the other. Again, this is to enable the detection of the direction of movement of a person, vehicle, or still other object either towards the corresponding intersection, or away from it.

At 2110, a processor component of a detection device (e.g., the processor component 355 of one of the detection devices 300a, 300b, 300c, 300x or 300y) monitors a pair of sensors of the detection device (e.g., the sensors 310 and 311) for an instance of a 1st sensor of the pair that is located further from an intersection being triggered first, at a time when the 2nd sensor of the pair is not triggered. At 2112, if such an instance has not yet occurred, then monitoring for such an instance continues at 2110.

However, if at 2112, such an instance of the 1st sensor being triggered while the 2nd sensor is not, then at 2120, the processor component monitors the 2nd sensor for being trigged within a 1st time period after the 1st sensor was triggered (e.g., within 1 second of the 1st sensor being triggered). At 2122, if the 2nd sensor is not triggered within that 1st time period, then the processor component returns to monitoring for an instance of the 1st sensor being triggered while the 2nd sensor is not at 2110.

However, if at 2122, the 2nd sensor is triggered within the 1st time period after the 1st sensor was triggered, then at 2130, the processor component operates an interface of the detection device (e.g., an interface 390 of one of the detection devices 300a, 300b, 300c, 300x or 300y) to transmit a command to a corresponding warning device (e.g., the warning device 500) to begin providing a warning of the likely imminent entry of crossing traffic into the intersection.

At 2140, the processor component monitors the 2nd sensor for an instance of an end to being triggered that is followed by the elapsing of at least a 2nd period of time (e.g., 4 seconds) without the second sensor being triggered again. At 2142, if such an instance has not yet occurred, then monitoring for such an instance continues at 2140.

However, if at 2142, such an instance of the 2nd sensor ceasing to be triggered followed by at least the elapsing of the 2nd period of time without the 2nd sensor being triggered again, then at 2150, the processor component operates the same interface of the detection device to transmit another command to the warning device to cease providing the warning. The processor component then returns to monitoring for an instance of the 1st sensor being triggered while the 2nd sensor is not triggered at 2110.

1. An intersection collision avoidance system comprising a warning device and at least two detection devices, wherein:
each detection device of the at least two detection devices comprises a pair of sensors to distinguish a direction of movement of a person or vehicle from between movement along a first pathway toward an intersection and movement along the first pathway away from the intersection; and
the warning device provides a visual and/or audible warning to another person or vehicle moving along a second pathway toward the intersection of likely imminent entry of the person or vehicle into the intersection in response to detection, by one of the at least two detection devices, of the person or vehicle moving toward the intersection along the first pathway.

2. The system of claim 1, wherein each detection device of the at least two detection devices comprises a pair of sensors that define a pair of paths by which the detection device may distinguish the direction of movement of the person or vehicle.

3. The system of claim 2, wherein each detection device of the at least two detection devices comprises a processing component, wherein the processing component is caused, by execution of a control routine, to operate the pair of sensors to detect the direction of movement of the person or vehicle along the first pathway.

4. The system of claim 1, wherein the warning device comprises at least one warning indicator to provide the warning to the other person or vehicle of likely imminent entry of the person or vehicle along the first pathway and into the intersection.

5. The system of claim 4, wherein the warning device comprises a processing component, wherein the processing component is caused, by execution of a control routine, to:
monitor for reception of a signal from a detection device of the at least two detection devices; and
in response to the reception of the signal, operate the least one warning indicator to provide the warning.

6. A method comprising:
detecting, by a detection device of an intersection collision avoidance system, movement of a person or vehicle along a first pathway toward an intersection; and
providing, by a warning device of the intersection collision avoidance system, a warning to another person or vehicle approaching the intersection along a second pathway in response to detecting, by the detection device, the person or vehicle moving toward the intersection along the first pathway.
